(19) United States
(12) Patent Application Publication
(10) Pub. No.: US 2024/0215488 A1
(43) Pub. Date: Jul. 4, 2024

(54) METHOD FOR FRUIT QUALITY INSPECTION AND SORTING DURING AND BEFORE PICKING

(71) Applicant: TEVEL AEROBOTICS TECHNOLOGIES LTD., Modiin (IL)

(72) Inventors: Adi TAFLIA, Modiin (IL); Yaniv MAOR, Modiin (IL); Nadav DAN-GUR, Modiin (IL)

(21) Appl. No.: 18/288,780

(22) PCT Filed: Apr. 28, 2022
(86) PCT No.: PCT/IL2022/050430

§ 371 Date: Oct. 27, 2023

(30) Foreign Application Priority Data
Apr. 29, 2021 (IL) 282797

(51) Int. Cl. A01D 46/30

(52) U.S. Cl. CPC A01D 46/30

(57) ABSTRACT

The present invention provides a method for on-site identification of damaged fruits and ripeness assessment, immediately after picking/harvesting, thereby enabling discarding damaged fruits on-site without delivering such damaged fruits to a warehouse, which also reduces harvesting time and improves harvesting efficiency. The method of the invention enables improved sorting compared to known robotic harvesters as it is based on a 360° inspection of the fruit and without having the leaves and branches interfere. The method of the invention further enables a preliminary sorting of the fruits according to determined fruits' grade based on identified blemishes in each fruit.

### FIELD OF THE INVENTION

The present invention is in the technical field of agriculture technology, specifically autonomous harvesting. More particularly, the present invention relates to devices, systems and methods for identification, sorting, and removal of damaged harvested fruits on-site (immediately after harvesting before fruit arrived to the bin).

### BACKGROUND

A human picker picks fruits by pulling and rotating the fruit simultaneously. Pulling a fruit without rotating it can damage the fruit or its shell, e.g. the fruits' shell integrity, which exposes the inside of the fruit to the surroundings and shortens the fruit's shelf life. In addition, often fruits are damaged due to bruisers (e.g. from nearby branches), pests, and other diseases.

A human picker can detect such damaged fruits and discard them on-site. However, often human pickers are required to meet a quota, which makes them ignore such damaged fruits or not examine the harvested fruit at all. In addition, known fruit harvesting devices, while designed to harvest and collect fruits, are not designed to differentiate between a damaged fruit and a “good” (un-damaged) fruit. These leads to a situation in which damaged fruits are delivered to a warehouse for sorting and long-term storage.

For determine if a fruit is damaged or un-damaged, a 360° interior and exterior fruit-scanning is required. By nature, one side of the fruit is exposed to the human picker or robot and one side is hidden and cannot been observed by the human picker or robot. Mostly, the exposed side is also partially hidden by leaves and quality observation can be done only with rotating the fruit after it is removed from the branch.

In addition, to determine if a fruit is ripe, fruit's color assessment is required. The color of a fruit is not uniform since that external fruit parts that are exposed to the sun tend to be more “red” (“ripe”), whereas the hidden parts are, which are not exposed to the sun, tend to be “greener”. There are fruit variety that has ripeness criteria of both sides for ripeness determination.

The costs of fruits' delivery to the warehouse and their long-term storage are dependent on fruits' amount, and as such it is advisable to minimize the amount of damaged harvested fruits being transported to the warehouse and stored.

Various developments were made to automatically detect damaged fruits. For instance, WO 2018/002841 describes an apparatus for detecting damaged fruit and vegetable products, the apparatus comprising a conveyor, means for capturing one or more images of the fruits, and processing means to define a specific condition or feature of the respective product to allow applying a subsequent command for unloading the product from the conveyor.

CN 103439270 describes a device and a method for detecting cold damage of peach fruits based on reflection and semi-transmission hyperspectral images, to reduce loss of storage of harvested fruits, and for detection and monitoring in circulation, storage and marketing process of the harvested fruits. CN 101059452 discloses a fruit quality non-damage detect method and system, based on multi-spectrum image technique, to analyze defects in fruits, to realize non-damage quick fruit quality detect system.

U.S. Pat. No. 3,768,645 describes an apparatus and method for automatically evaluating citrus fruits, on the basis of the uniformity and non-uniformity of their transparency to X-rays and selectively separating them into different grades according to such evaluations, the fruit being oriented and carried by a conveyor in a path between an X-ray source and X-ray detectors positioned to straddle the fruit core portion, wherein the percentage of internal damage is computed for each fruit, after which the fruits are successively separated into different predetermined grades according to their respective damage evaluations.

U.S. Pat. No. 4,122,951 provides a machine that is capable of detecting blemishes in olives and similar products passing on a conveyor, and subsequently select the products based on their size and possible blemishes.

U.S. Pat. No. 9,174,245 provides a system for identifying pieces of fruit affected by any amount of rot and to determine the automatic expulsion of these pieces from the conveyor moving them through the installation.

However, all of the above (and other) systems, devices and method, are aimed at detecting and soring damaged fruits that are already at a warehouse and are about to be stored, wrapped or shipped and wasted. Damaged fruit has no commercial value, so farmers and warehouse actually loose money from wasted product (it has a negative value).

Accordingly, a need exists for an efficient autonomous harvester equipped with the ability to determine on-site, immediately after picking, whether a fruit is “good” and should be placed in a collection bin for transport to the warehouse, or damaged and should be discarded.

### SUMMARY OF THE INVENTION

The present invention provides a method for automatically selecting, sorting and discarding harvested damaged fruits during harvesting by an unmanned autonomous harvester (UAH), the method comprising the steps of: (a) immediately after grasping a fruit or immediately after detaching it from the branch, while holding the fruit with a harvesting arm, scanning the fruit from different angles; (b) analyzing the scan of the fruit from different angles and identifying blemishes; and (c) determining/evaluating whether the identified blemishes render the fruit as damaged or not, wherein the method is carried out on-site in the orchard immediately for each fruit that is harvested, such that if the fruit is determined/evaluated as damaged, the UAH discharges/disposes the fruit and continues harvesting, and if the fruit is determined/evaluated as not-damaged, it is placed in a collection bin and the UAH continues harvesting.

The present invention further provides a method for automatically selecting, sorting and discarding harvested damaged fruits during harvesting by an unmanned autonomous harvester (UAH) equipped with a harvesting arm having a fruit-gripper assembly, the method comprising the steps of: (a) immediately after grasping a fruit and immediately after detaching it from the branch, while holding the fruit with said harvesting arm, scanning 360° of said fruit; (b) analyzing the scan and identifying and classifying blemishes within said fruit; and (c) determining whether the identified blemishes render the fruit as damaged or not, wherein: the fruit-gripper assembly is based on suction-gripping by a suction-nipple that keeps over 90% of the fruit's surface visible for said scanning; and the method is carried out on-site in the orchard immediately for each fruit that is harvested, such that if a fruit is determined as damaged, the UAH discharges the fruit, optionally to the ground, and continues harvesting, and if the fruit is determined as not-damaged, it is placed in a collection bin and the UAH continues harvesting

The present invention further provides a method for harvesting fruits, comprising the steps of: (a) activating at least one unmanned autonomous harvester (UAH) equipped with a fruit-gripper assembly; (b) after detaching/disconnecting/picking a fruit and while holding the fruit, scanning the fruit from different angles; (c) identifying blemishes within the fruit; and (d) determining/evaluating whether the blemishes render the fruit as damaged or not, wherein the method is carried out on-site in the orchard for each harvested fruit, such that if a fruit is determined/evaluated as damaged, the harvester discharges/disposes the fruit and continues harvesting, and if a fruit is determined/evaluated as not-damaged, it is placed in a collection bin and the harvester continues harvesting.

The present invention further provides a method for harvesting fruits, comprising the steps of: (a) activating at least one unmanned autonomous harvester (UAH) equipped with a harvesting arm with a fruit-gripper assembly; (b) after detaching a fruit from a branch and while holding said fruit, scanning 360° of said fruit; (c) identifying blemishes within the fruit; and (d) determining whether said identified blemishes render the fruit as damaged or not, wherein: said fruit-gripper assembly is based on suction-gripping by a suction-nipple that keeps over 90% of the fruit's surface visible for scanning; and the method is carried out on-site in the orchard for each harvested fruit, such that if a fruit is determined as damaged, the harvester discharges the fruit and continues harvesting, and if a fruit is determined as not-damaged, it is placed in a collection bin and the harvester continues harvesting.

The present invention further provides a system for harvesting fruits, the system comprising an unmanned autonomous harvester (UAH) equipped with one or more harvesting arms and a fruit scanner, wherein the UAH is designed to: (a) scan each harvested fruit, immediately upon grasping it or immediately after detaching it from a branch and while holding the fruit with said harvesting arm; analyze each scan and identify blemishes; and determine/evaluate whether the identified blemishes render the fruit damaged or not; and (b) discard a fruit that is determined/evaluated as damaged and continue harvesting, and place a fruit that is determined/evaluated as not-damaged in a fruit collection bin and continue harvesting.

The present invention further provides a system for harvesting fruits, the system comprising a unmanned autonomous harvester (UAH) equipped with one or more harvesting arms having a fruit-gripper suction-gripping based assembly, and a fruit scanner, wherein the UAH is designed to: (a) scan each harvested fruit, immediately after detaching it from a branch and while holding the fruit with said harvesting arm; analyze each scan and identify blemishes; and determine whether the identified blemishes render the fruit is damaged or not; and (b) discard a fruit that is determined as damaged and continue harvesting, and place a fruit that is determined as not-damaged in a fruit collection bin and continue harvesting.

### BRIEF DESCRIPTION OF THE DRAWINGS

FIGS. 1A-IC illustrate the gripping of a fruit and rotation thereof after picking.

FIGS. 2A-2G are pictures of actual fruits illustrating the identification of a damage and its respective damage percentage.

FIGS. 3A-3F are pictures of actual fruits illustrating identification of various specific blemishes and their respective damage percentage.

FIGS. 4A-4G are pictures of an actual fruit illustrating the identification of damage-percentage thereof during a 360° scan.

### DETAILED DESCRIPTION

In agriculture, there is a constant requirement for machines and equipment for harvesting fruits, of all types, especially those with soft shells that are defined as high value crop that tend to bruise during picking, such as apples, pears, apricots, plums, mango, peaches, citrus fruits, avocado, tomatoes, eggplants, cucumbers and peppers. Accordingly, various machines and harvesters have been developed, usually designed for picking a specific type of fruit or family of fruits.

Manual pickers pick/harvest fruit and put damaged/defected fruit in the collection bin since they do not have the patience and time for high quality sorting. As a result, 4-8% of the picked fruits are defective and have no commercial value or even negative commercial value. Moreover, they may damage good nearby fruits during storage.

Toady, harvested fruits are delivered to a warehouse and stored for 1-12 months. Only when they are taken out to a sorting house, damaged fruits are identified and removed. During all this time, the farmer pays for the storage and transportation of such damaged fruits, and the damaged fruits may further infect surrounding fruits and cause damaged to nearby healthy fruits.

The identification of such damaged fruits is done either manually or automatically by machines by inspecting fruits along a moving conveyor. As explained above, these is not cost effective since it requires the delivery and storage of damaged fruits.

Existing harvesting robots sort fruits during harvesting according to a visual fruit's quality grade as identified when the fruit is still on the tree. At best, the sensors cover 180° of the fruit, and the presence of leaves and branches reduces their visibility and accuracy even more. After such robots determine that the fruit is suitable for harvesting, they pick the fruit and place it in a single fruit collection bin-without further inspection or evaluation of its condition. In fact, all actual fruits' sorting done today is carried out in a sorting-house, after storage and transfer of the fruit from the orchard to the sorting-house. Some farmers enlarge their quality assurance team to inspect and remove damaged fruit from the fruit collection bin, after the bin is full. Such inspection process is time consuming, intensive, expensive and has limited performance as a quality assurance team doesn't have the capability to inspect all fruit.

Accordingly, the present invention provides a method for on-site identification of damaged fruits and ripeness assessment, immediately after picking/harvesting, thereby enabling discarding damaged fruits on-site without delivering such damaged fruits to a warehouse, which also reduces harvesting time and improves harvesting efficiency. The method of the invention enables improved sorting compared to known robotic harvesters as it is based on a 360° inspection of the fruit and without having the leaves and branches interfere. The method of the invention further enables a preliminary sorting of the fruits according to determined fruits' grade based on identified blemishes in each fruit.

Such on-site identification and determination assist in reducing the harvesting time and improves AUH's energy usage during harvesting, since when a damaged fruit is identified, the AUH does not need to go back to the collection bin for placing the fruit therein, and it can simply drop it to the ground and continue harvesting the next fruit.

Accordingly, in a first aspect, the present invention provides a method for automatically selecting, sorting and discarding harvested damaged fruits during harvesting by an unmanned autonomous harvester (UAH), the method comprising the steps of: (a) immediately after grasping a fruit or immediately after detaching it from the branch (i.e. after harvesting), while holding the fruit with a harvesting arm, scanning the fruit from different angles; (b) analyzing the scan and identifying and classifying blemishes; and (c) determining/evaluating whether the identified blemishes render the fruit as damaged or not, wherein the method is carried out on-site in the orchard immediately for each fruit that is harvested, such that if the fruit is determined/evaluated as damaged, the UAH discharges/disposes the fruit and continues harvesting, and if the fruit is determined/evaluated as not-damaged, it is placed in a collection bin and the UAH continues harvesting. N specific embodiments, step (b) further comprises analyzing the fruit's color(s) from different angles thereof, e.g., to determine the fruit's ripeness. This means that the method enables additional sorting of the fruits according to their ripeness level, according to the fruits' color from all sides thereof (which is not possible when the fruits are still on the tree).

The term “damaged fruit” as used herein refers to any fruit that is damaged—for any reason. For instance, a bruised fruit due to getting hit from a branch; an infected fruit from an insect bite/sting; a (bird) bitten fruit, or combinations thereof.

The determination/evaluation whether the identified blemishes render a fruit as damaged or not, and/or the determination of a fruit's grade, can be carried out using any suitable algorithm, such as algorithms that are based on artificial intelligence (AI) trained neural network, and spots vision detection algorithms.

In certain embodiments, the scanning of the fruit means scanning its exterior, its interior or both. This enables identification of both external blemishes, such as black spots, insect stings and bird bites, as well as internal blemishes, such as internal bruises, internal lice growing, rotten internal organs, etc.

In certain embodiments, the identification of the blemishes is based on RGB (e.g. identification of minor color changes), depth (e.g. groves and bumps on the fruit's surface), UV (to identify fungus, insects, etc.), polarizer (to identify brix and water percentage and surface texture), thermal imaging, IR, X-ray, and any other multispectral imaging that can support detection of defects.

In certain embodiments, the scanning of the fruit is accompanied by illumination thereof using an illuminator (i.e. a light source) within the UAV. The illumination can be of light of any wavelength, such as visible light, IR and UV.

Accordingly, in certain embodiments, the method of the invention comprises the steps of: (a) immediately after grasping a fruit or immediately after detaching it from the branch (i.e. after harvesting), while holding the fruit with a harvesting arm, scanning the fruit's exterior, interior or both, from different angles, optionally while illuminating the fruit using an illuminator within the UAH; (b) analyzing the scan and identifying and classifying blemishes; and (c) determining/evaluating by a dedicated algorithm, such as AI trained neural network, whether the identified blemishes render the fruit as damaged or not, wherein the method is carried out on-site in the orchard immediately for each fruit that is harvested, such that if the fruit is determined/evaluated as damaged, the UAH discharges/disposes the fruit and continues harvesting, and if the fruit is determined/evaluated as not-damaged, it is placed in a collection bin and the UAH continues harvesting.

In certain embodiments, the method according to any of the embodiments above further comprises the following steps: (d) determining on-site a fruit's grade according to the determined/identified blemishes; and (e) placing each fruit in a suitable collection bin according to its determined grade (i.e. sorting the harvested fruits according to their classification), in which case, the UAV performs on-site sorting of the fruits being harvested according to fruits' grade determined by the identified blemishes of each fruit. This means that the UAV sorts the harvested fruits on-site based on their determined/identified blemishes which correlates to fruits' grades, such that a too-damaged fruit is thrown away (dropped to the ground); a semi-damaged fruit, with a low commercial value is delivered to a dedicated collection bin; and a non-damaged fruit with a high commercial value is delivered to another collection bin. And optionally another step of uploading the fruit blemishes data to a cloud, optionally with the blemishes' absolute position.

The term “blemishes” as used herein means bruising, infections, fungus, insect stings, bites, rotten, moth, scab, sunburn, pitting, etc., or any other possible imperfection of a fruit as defined from time to time, such as bumps and groves, coloring, spots, etc.

The term “grade” as used herein with reference to fruit's grade, means determination of a fruit's condition and classifying the fruits accordingly. For instance, a fruit that is flawless is classified as “Grade A”; a fruit with some insignificant color spots and/or minor groves and bumps, is classified as “Grade B”; and a rotten fruit or a fruit with significant color-differentiation and/or fungus/bruising/infections/etc., is classified as “Grade C” or as unsuitable for consumption. Another (or in addition) classification is based on the fruit's ripeness level, which is determined according to the color of the whole fruit (i.e. from all sides thereof).

The fruit's scanning according to the method of the invention can be carried in any suitable manner. For instance, the scanning can be carried out by rotating the fruit itself by the UAH's harvesting arm in front of an optical image capturing device, such as a camera that is located onto the UAH, to allow scanning the fruit. Alternatively, the optical image capturing device itself can be rotated around the fruit that is held by the harvesting arm. In specific embodiments, both the fruit and the image capturing device rotate simultaneously. In certain embodiments, the scanning of the fruit is carried out by an optical image capturing system comprising an image capturing device and at least one mirror-in such a case either the fruit is rotated between the device and the mirror, or the device and mirror are rotated around the fruit, or both the device, mirror and fruit rotate simultaneously.

Accordingly, in certain embodiments, the method of the invention comprises the steps of: (a) immediately after grasping a fruit or immediately after detaching it from the branch (i.e. after harvesting), while holding the fruit with a harvesting arm, scanning the fruit's exterior, interior or both, from different angles, optionally while illuminating the fruit using an illuminator within the UAH, wherein the scanning is by rotating the fruit around in-front of an image capturing device, or vise-versa, or rotating both the fruit and the image capturing device; (b) analyzing the scan and identifying and classifying blemishes; and (c) determining/evaluating by a dedicated algorithm, such as AI trained neural network, whether the identified blemishes render the fruit as damaged or not, wherein the method is carried out on-site in the orchard immediately for each fruit that is harvested, such that if the fruit is determined/evaluated as damaged, the UAH discharges/disposes the fruit and continues harvesting, and if the fruit is determined/evaluated as not-damaged, it is placed in a collection bin and the UAH continues harvesting. In specific embodiments, the method further comprises the following steps: (d) determining on-site a fruit's grade according to the determined/identified blemishes; and (e) placing each fruit in a suitable collection bin according to its determined grade, in which case, the UAV performs on-site sorting of the fruits being harvested according to fruits' grade determined by the identified blemishes of each fruit.

In certain embodiments of the method according to any of the embodiments above, the identification of the fruits' blemishes is: (i) carried out using visible and near infrared multispectral imaging instrument(s) and/or a polarizer imager; and/or (ii) on the outside surface of the fruit and/or on the inside surface of the fruit.

In a second aspect, the present invention provides a method for automatically harvesting fruits, the method comprising the steps of: (a) activating at least one unmanned autonomous harvester (UAH) equipped with a fruit-gripper assembly; (b) after detaching/disconnecting/picking a fruit and while holding the fruit, scanning the fruit from different angles; (c) identifying blemishes within the fruit; and (d) determining/evaluating whether the blemishes render the fruit as damaged or not, wherein the method is carried out on-site in the orchard for each harvested fruit, such that if a fruit is determined/evaluated as damaged, the harvester discharges/disposes the fruit and continues harvesting, and if a fruit is determined/evaluated as not-damaged, it is placed in a collection bin and the harvester continues harvesting.

In specific embodiments, the scanning of the fruit in step (b) means scanning the fruit's exterior, interior, or both.

In certain embodiments, the method for automatically harvesting fruits according to any of the embodiments above further comprises step (e) of determining a fruit's grade according to the identified blemishes; and optionally step (f) of placing the fruit in a suitable fruit-collection bin according to the determined fruit's grade.

Accordingly, in certain embodiments, the present invention provides a method for automatically harvesting fruits, the method comprising the steps of: (a) activating at least one unmanned autonomous harvester (UAH) equipped with a fruit-gripper assembly; (b) after detaching/disconnecting/picking a fruit and while holding the fruit, scanning the fruit's exterior, interior, or both, from different angles; (c) identifying blemishes within the fruit; (d) determining/evaluating whether the blemishes render the fruit as damaged or not; (e) determining a fruit's grade according to the identified blemishes; and optionally (f) placing the fruit in a suitable fruit-collection bin according to the determined fruit's grade, wherein the method is carried out on-site in the orchard for each harvested fruit, such that if a fruit is determined/evaluated as damaged, the harvester discharges/disposes the fruit and continues harvesting, and if a fruit is determined/evaluated as not-damaged, it is placed in a collection bin and the harvester continues harvesting.

In certain embodiments, the method for automatically harvesting fruits according to any of the embodiments above further comprises a step of storing data regarding the identified blemishes together with the fruit's global position on the tree.

Accordingly, in certain embodiments, the present invention provides a method for automatically harvesting fruits, the method comprising the steps of: (a) activating at least one unmanned autonomous harvester (UAH) equipped with a fruit-gripper assembly; (b) after detaching/disconnecting/picking a fruit and while holding the fruit, scanning the fruit's exterior, interior, or both, from different angles; (c) identifying blemishes within the fruit and storing data regarding the identified blemishes together with the fruit's global position on the tree; (d) determining/evaluating whether the blemishes render the fruit as damaged or not; and optionally steps (e) and (f) of: (e) determining a fruit's grade according to the identified blemishes; and (f) placing the fruit in a suitable fruit-collection bin according to the determined fruit's grade, wherein the method is carried out on-site in the orchard for each harvested fruit, such that if a fruit is determined/evaluated as damaged, the harvester discharges/disposes the fruit and continues harvesting, and if a fruit is determined/evaluated as not-damaged, it is placed in a collection bin and the harvester continues harvesting.

In specific embodiments of the method for automatically harvesting fruits according to any of the embodiments above, the fruit-gripper assembly is based on suction-gripping by a suction/vacuum-nipple. In further or alternative embodiments thereof, the UAH is a flying UAH. In certain embodiments, the suction/vacuum-nipple is flexible thereby enabling its fitting to any fruit of any shape and size.

The terms “vacuum” and “suction” as used herein interchangeably refer to negative pressure or generation thereof, i.e., by the removal of air from a space, i.e. between the suction-nipple of the invention and an object (e.g., a fruit), thereby enabling attachment/adhesion of the nipple to the object.

In certain embodiments, the suction/vacuum-nipple according to the invention comprises an interlock mechanism that prevent the release of a fruit to which the nipple it attached during rotational movement of the harvesting arm or the nipple itself. In such a case, the suction-nipple has two configurations: (i) a first open-configuration when the nipple is not attached to a fruit (or to any other desired object) and no vacuum is generated between the fruit and nipple, in which configuration the interlock mechanism is in an open-orientation enabling free twisting of the nipple on its axis; and (ii) a second locked/crammed-configuration when the nipple is attached to a fruit (or to any other desired object) and vacuum/sucking is applied, in which configuration the interlock mechanism is in a locked-orientation that prevents any twisting of the nipple on its axis, which prevent deforming of the nipple's shape which might cause the release of the fruit therefrom.

When a suction-nipple according to the invention comes in contact with a fruit that needs picking, and vacuum is applied, the pressure inside the nipple is lowered (i.e., vacuum begins to generate). Finally, when the nipple is fully squeezed, the locking mechanism is in its locked-orientation, which enables applying forces on the fruit for picking, such as rotation and tilting forces, without releasing the nipple from the fruit.

In certain embodiments, the suction/vacuum-nipple of the invention is flexible thereby enabling its fitting to any shape and size. Accordingly, the suction-nipple of the invention can be used for harvesting any type, size and shape of fruit or vegetable without damaging or dropping the fruit. When the suction-nipple of the invention is used for other purposes, e.g. industry, sorting, etc., it can be used for picking objects of any type, size and shape, without risking of damaging or dropping such objects.

In certain embodiments, the suction-nipple of the invention is made of any suitable flexible material such as rubber, silicon, etc.

In certain embodiments, the flying UAH of the invention further comprises at least one of: (i) a vacuum/suction-generator for enabling generation of vacuum that facilitate gripping of a fruit by said nipple; (ii) an air-blower designed to blow air through the nipple as it approached a fruit thereby pushing away leaves that otherwise get stacked in between the nipple and the fruit and impair or prevent vacuum generation between the nipple and the fruit; (iii) a tilting motor for moving said harvesting arm for tilting a fruit gripped by the nipple for picking the fruit; and (iv) a rotation motor for rotating or tilting said nipple and/or the entire harvesting arm for picking the fruit.

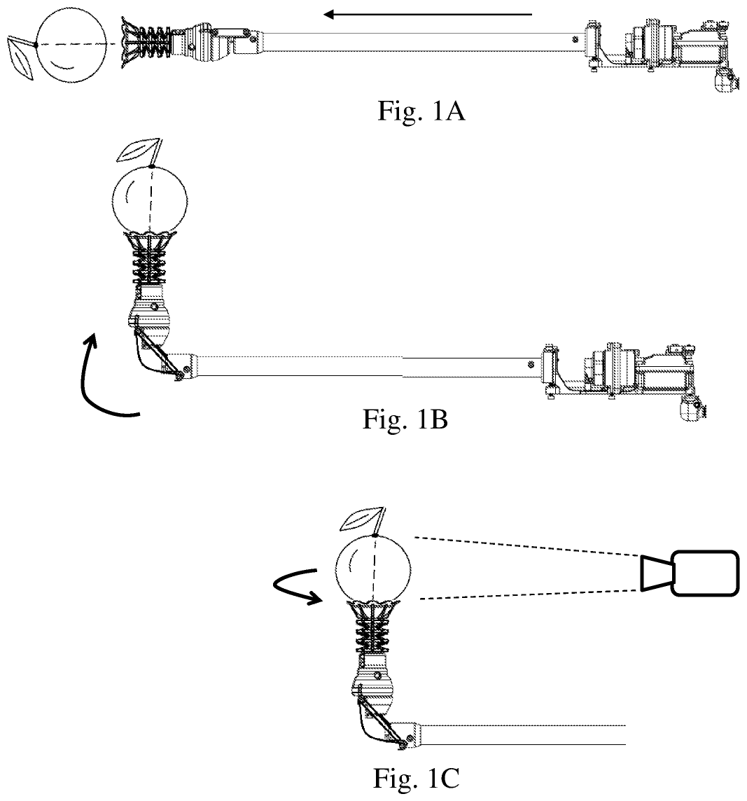

FIG. 1A illustrates how a harvesting arm of a UAH reaches a fruit and grasps it. Then, while the fruit is still being held by the arm, the fruit is positioned in front of an image capturing device for scanning the fruit's exterior, interior or both (FIG. 1B shows that the arm's tip holding the fruit is turned in a 90° angle to be placed in front of an image capturing device located on the UAH), for the identification of blemishes. Then, and as illustrated in FIG. 1C, the fruit is turned around in-front of the image capturing device to scan 360° of the fruit.

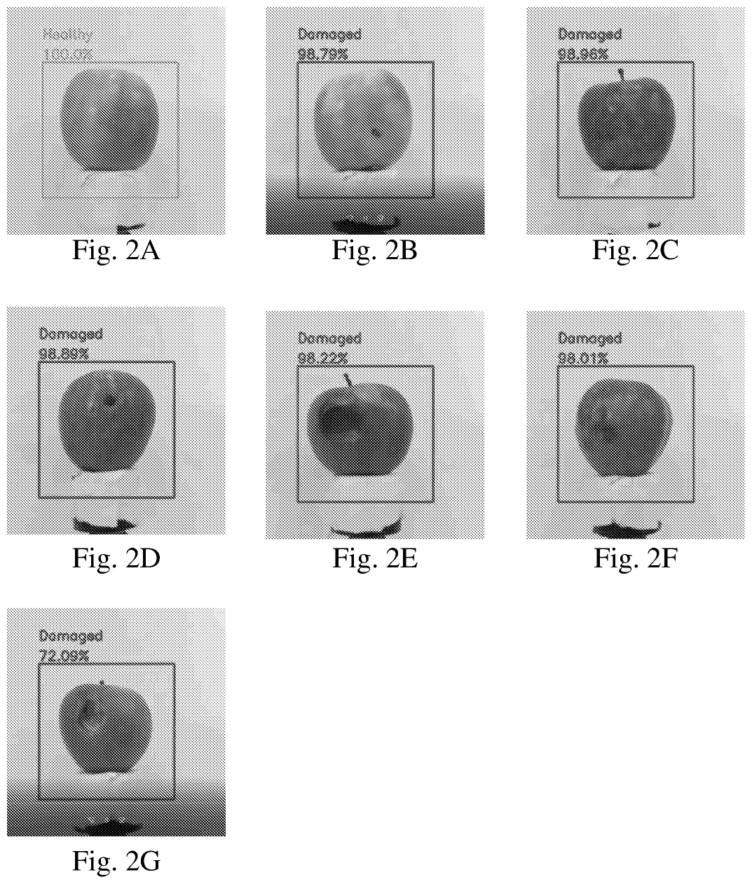

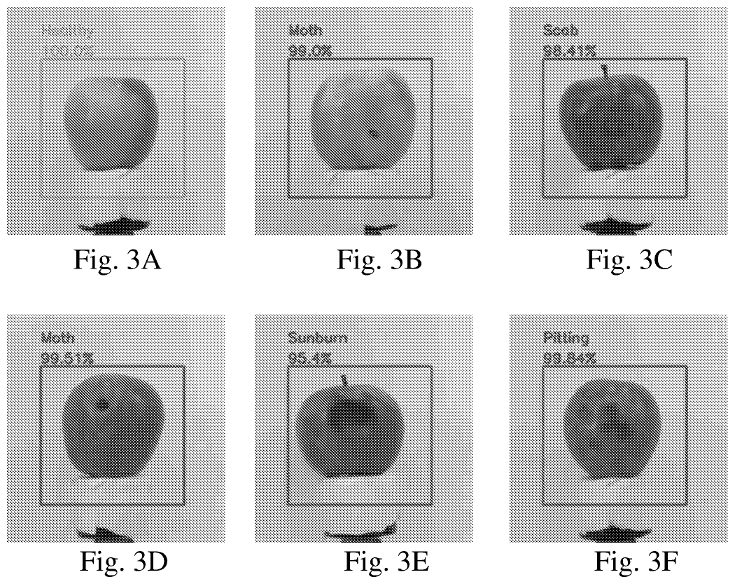

FIGS. 2 and 3 provide actual pictures of various apples, wherein FIGS. 2A and 3A are of a comparison healthy apple. FIGS. 2B-2G illustrate the possibility of the method of the invention to identify the presence of blemishes in a fruit, without referring to the type of blemish. As exemplified, the method enables to identify various blemishes, of any type, and determine their respective damage-percentage per fruit as basis for classification determination thereof. FIGS. 3B-3F illustrate the possibility of the method of the invention to identify not only the presence of blemishes in a fruit, but also the type of blemish: as exemplified, the method enables to identify various blemish types, and determine their respective damage-percentage per fruit as basis for classification determination thereof.

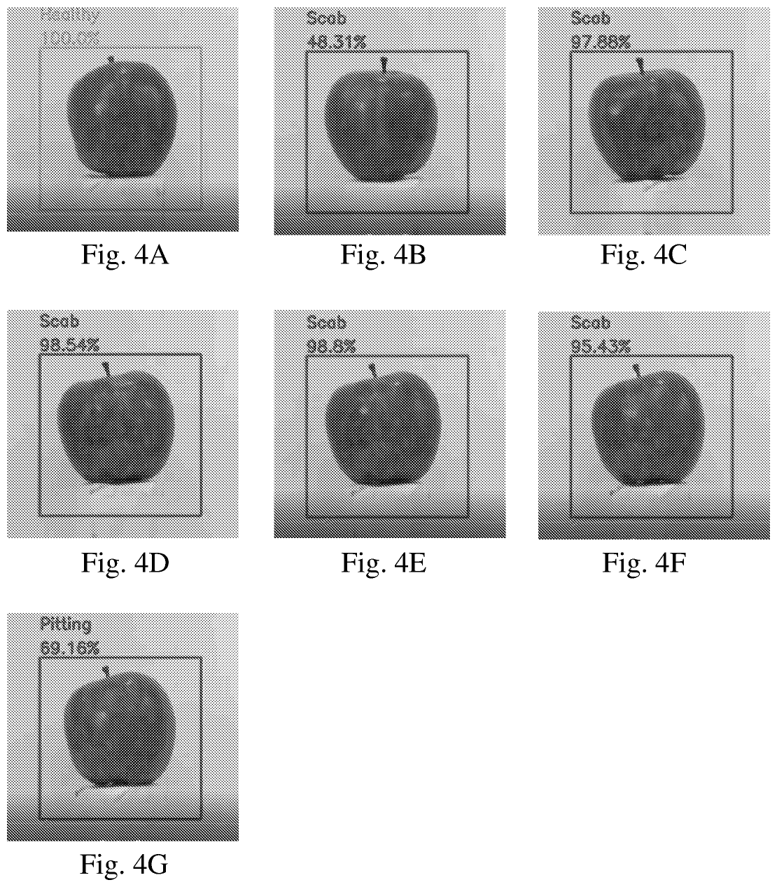

The method according to any of the embodiments above is based on a 360° scan of each fruit for the identification of blemishes all around. During this 360° scan, the fruit is scanned, and the final classification thereof is calculated according to the overall identified damage-percentage. FIGS. 4A-4G are pictures of a single fruit during a 360° scan thereof, showing different damage-percentages identified at different time frames/intervals during the scan. As seen, the damage-percentage changes according to the angle of the scan, and the final classification and determination of the fruit's grade is determined according to the total measured damage-percentages during the entire scan. One example of such a grading algorithm performed by the system and method of the invention is: Grade=ColorMatch×SizeMatch×DefectsClean, while ColorMatch=Actual color/Expected color, SizeMatch=Actual size/Expected size and DefectsClean=if there is a defect 0, no defect is 1.

In a third aspect, the present invention provides a system for harvesting fruits, the system comprising an unmanned autonomous harvester (UAH) equipped with one or more harvesting arms and a fruit scanner, wherein the UAH is designed to: (a) scan each harvested fruit, immediately upon grasping it or immediately after detaching it from a branch (i.e. harvesting) and while holding the fruit with said harvesting arm; analyze each scan and identify blemishes; and determine/evaluate whether the identified blemishes render the fruit damaged or not; and (b) discard a fruit that is determined/evaluated as damaged and continue harvesting, and place a fruit that is determined/evaluated as not-damaged in a fruit collection bin and continue harvesting.

In specific embodiments, the above system is intended for carrying out any of the above-mentioned methods of the invention for: (i) automatically selecting, sorting and discarding harvested damaged fruits during harvesting by an unmanned autonomous harvester (UAH) and/or (ii) automatically harvesting fruits.

In certain embodiments of the system according to the invention, the UAH is also designed to determine a fruit's grade/classification according to the identified blemishes, and optionally to place each fruit in a dedicated fruit collection bin according to the fruit's determined grade. Such information about fruit blemishes/damages/grade combined with the fruit's position and posture is stored in a database for farther analysis for corrective actions.

In certain embodiments, the system according to the invention further comprises at least one fruits' collection bin.

Accordingly, in certain embodiments, the present invention provides a system for harvesting fruits, the system comprising: (i) at least one fruits' collection bin; and (ii) an unmanned autonomous harvester (UAH) equipped with one or more harvesting arms and a fruit scanner, wherein the UAH is designed to: (a) scan each harvested fruit, immediately upon grasping it or immediately after detaching it from a branch (i.e. harvesting) and while holding the fruit with said harvesting arm; analyze each scan and identify blemishes; determine/evaluate whether the identified blemishes render the fruit damaged or not; (b) discard a fruit that is determined/evaluated as damaged and continue harvesting, and place a fruit that is determined/evaluated as not-damaged in a fruit collection bin and continue harvesting; (c) determine a fruit's grade/classification according to the identified blemishes, and (d) optionally, place each fruit in a dedicated fruit collection bin according to the fruit's determined grade.

1. A method for automatically selecting, sorting and discarding harvested damaged fruits during harvesting by an unmanned autonomous harvester (UAH) equipped with a harvesting arm having a fruit-gripper assembly, the method comprising the steps of:
immediately after grasping a fruit and immediately after detaching it from the branch, while holding the fruit with said harvesting arm, scanning 360° of said fruit;
analyzing the scan and identifying and classifying blemishes within said fruit; and
determining whether the identified blemishes render the fruit as damaged or not, wherein:
the fruit-gripper assembly is based on suction-gripping by a suction-nipple that keeps over 90% of the fruit's surface visible for said scanning; and
the method is carried out on-site in the orchard immediately for each fruit that is harvested, such that if a fruit is determined as damaged, the UAH discharges the fruit, optionally to the ground, and continues harvesting, and if the fruit is determined as not-damaged, it is placed in a collection bin and the UAH continues harvesting.

2. The method of claim 1, wherein the scanning of the fruit means scanning its exterior, interior or both.

3. The method of claim 1, further comprising steps of determining on-site a fruit's grade based on said identified and classified blemishes, and placing each fruit in a suitable collection bin according to its determined grade.

4. The method of claim 1, further comprising a step of uploading the fruit blemishes data to a cloud.

5. The method of claim 1, wherein the scanning of the fruit is carried out by rotating the fruit by said suction-nipple in front of an optical image capturing device to allow scanning the fruit.

6. The method of claim 1, wherein the scanning of the fruit is carried out by rotating an optical image capturing device around the fruit that is held by said harvesting arm.

7. The method of claim 1, wherein the scanning of the fruit is carried out by an optical image capturing system comprising an image capturing device and at least one mirror.

8. The method of claim 1, wherein the identification of blemishes is carried out using visible and near infrared multispectral imaging instrument(s) and/or a polarizer imager.

9. The method of claim 1, wherein the identification of blemishes is on the outside surface of the fruit, on the inside surface of the fruit, or both.

10. A method for harvesting fruits, comprising the steps of:
activating at least one unmanned autonomous harvester (UAH) equipped with a harvesting arm with a fruit-gripper assembly;
after detaching a fruit from a branch and while holding said fruit, scanning 360° of said fruit;
identifying blemishes within the fruit; and
determining whether said identified blemishes render the fruit as damaged or not, wherein:
said fruit-gripper assembly is based on suction-gripping by a suction-nipple that keeps over 90% of the fruit's surface visible for scanning; and
the method is carried out on-site in the orchard for each harvested fruit, such that if a fruit is determined as damaged, the harvester discharges the fruit and continues harvesting, and if a fruit is determined as not-damaged, it is placed in a collection bin and the harvester continues harvesting.

11. The method of claim 10, wherein the scanning of the fruit in the step of after detaching a fruit from a branch and while holding said fruit, scanning 360° of said fruit means scanning the fruit's exterior, interior, or both.

12. The method of claim 10, further comprising steps of: determining a fruit's grade based on said identified blemishes; and placing the fruit in a suitable fruit-collection bin according to the determined fruit's grade

13. The method of claim 10, further comprising a step of storing data regarding the identified blemishes together with the fruit's global position on the tree.

14. The method of claim 1, wherein the UAH is a flying UAV.

15. A system for harvesting fruits, the system comprising an unmanned autonomous harvester (UAH) equipped with one or more harvesting arms having a fruit-gripper suction-gripping based assembly, and a fruit scanner, wherein the UAH is designed to:
scan each harvested fruit, immediately after detaching it from a branch and while holding the fruit with said harvesting arm; analyze each scan and identify blemishes; and determine whether the identified blemishes render the fruit is damaged or not; and
discard a fruit that is determined as damaged and continue harvesting, and place a fruit that is determined as not-damaged in a fruit collection bin and continue harvesting.

16. The system of claim 15, wherein the UAH is further designed to determine a fruit's grade based on the identified blemishes, and to place each fruit in a dedicated fruit collection bin according to the fruit's determined grade.

17. The system of claim 15, wherein the UAH is a flying UAV.
